(19) United States
(12) Patent Application Publication
(10) Pub. No.: US 2013/0329073 A1
(43) Pub. Date: Dec. 12, 2013

(54) Creating Adjusted Digital Images with Selected Pixel Values

(71) Applicant: Peter Majewicz, Boise, ID (US)

(72) Inventor: Peter Majewicz, Boise, ID (US)

(21) Appl. No.: 13/492,274

(22) Filed: Jun. 8, 2012

(51) Int. Cl. H04N 5/228; G06K 9/36; G06K 9/40

(52) U.S. Cl. 348/222.1; 382/254; 382/232; 348/E05.031

(57) ABSTRACT

Creating adjusted digital images with selected pixel values includes taking multiple digital images of a view where at least two of the digital images are taken with light from different angles and selecting pixels values from the at least two digital images to create an adjusted digital image.

### BACKGROUND

Photocopiers are image capture devices that copy relatively flat and two dimensional documents. Some photocopiers have a glass flatbed scanner with a moveable scanner and/or a sheet fed scanner where the document sheets move pass the scanner. The resulting photocopies are the same size as the original document unless a user specifically instructs otherwise. Many photocopiers allow a user to adjust the overall brightness of a copied document before instructing the photocopier to capture the document's image.

Another type of image capture device uses a digital camera that is positioned above a platform upon which a document is held to be photographed. To obtain a copy with this device, the digital camera takes a digital image of the document. This type of image capture device has less moving parts than the traditional photocopiers.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an illustrative system for taking a digital image, according to principles described herein.

FIG. 2 is a diagram of an illustrative system for taking a digital image, according to principles described herein.

FIG. 3 is a diagram of an illustrative adjusted digital image, according to principles described herein.

FIG. 4 is a diagram of illustrative pixel values, according to principles described herein.

FIG. 5 is a diagram of an illustrative adjusted digital image, according to principles described herein.

FIG. 6 is a diagram of illustrative pixel values, according to principles described herein.

FIG. 7 is a diagram of an illustrative user interface, according to principles described herein.

FIG. 8 is a diagram of an illustrative method for creating an adjusted digital image, according to principles described herein.

FIG. 9 is a diagram of an illustrative flowchart of a method for creating an adjusted digital image, according to principles described herein.

FIG. 10 is a diagram of an illustrative processor, according to principles described herein.

FIG. 11 is a diagram of a side view of an illustrative arrangement of light sources, according to principles described herein.

FIG. 12 is a diagram of a bottom view of an illustrative arrangement of light sources, according to principles described herein.

FIG. 13 is a diagram of a bottom view of an illustrative arrangement of light sources, according to principles described herein.

### DETAILED DESCRIPTION

Many cameras are equipped with light sources referred to as flashes to illuminate a scene to be photographed. While the purpose of the flash is to improve the image's quality, the flash can create shadows or glare on the objects to be photographed. When a digital image is taken of a three dimensional object, parts of the object may obstruct light from reaching the some areas in the camera's field of view. The obstructed areas may result in a shadow cast into the obstructed area leaving a darkened portion in the digital image. Further, the shape and material of a three dimensional object can also create a glare that results in a washed out area in the resulting digital image. The glare may be caused by a high intensity of light reflected back into the camera.

The present specification describes subject matter including, for example, a method for creating adjusted digital images with selected pixel values. Examples of such a method include taking multiple digital images of a view where at least two of the digital images are taken with light from different angles and selecting pixels values from the at least two of the digital images to create an adjusted digital image. The pixel values of the adjusted digital image may be selected to minimize glare or shadows.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

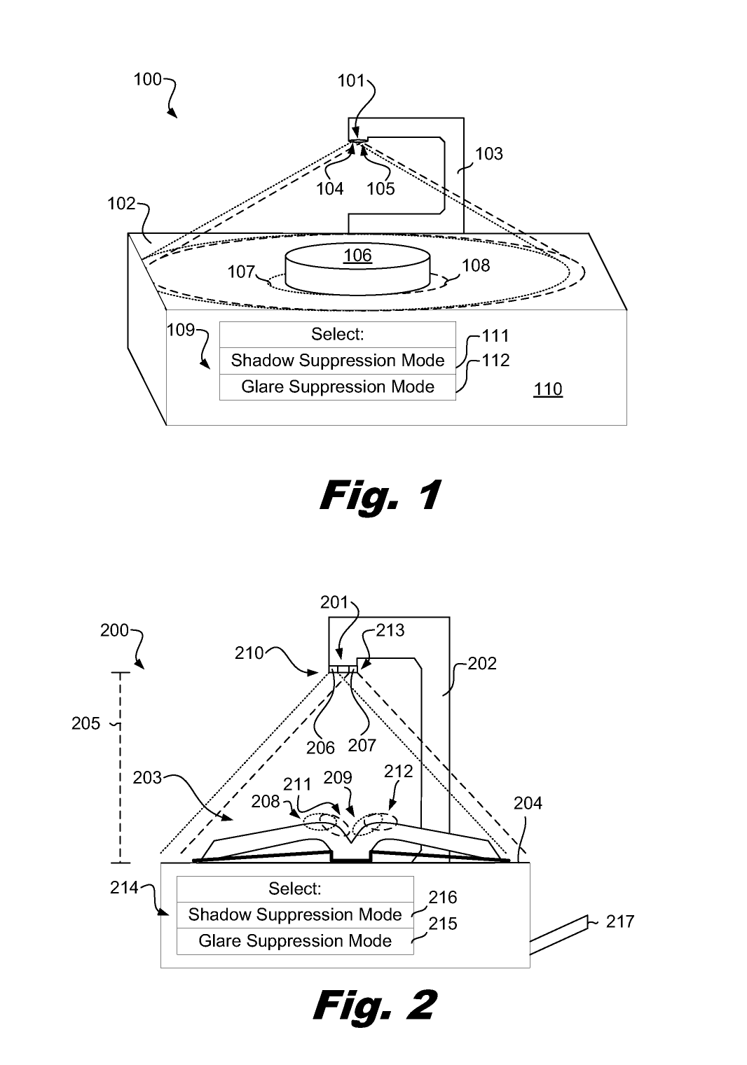

FIG. 1 is a diagram of an illustrative system (100) for taking a digital image, according to principles described herein. In this example, the system has a digital camera (101) positioned over a platform (102). The digital camera (101) is secured to the platform (102) with a post (103) that substantially positions the camera (101) over the center of the platform (102).

In the example of FIG. 1, the digital camera (101) has light directed towards the platform (102) from a first light source (104) and a second light source (105). The light from each light source (104, 105) may be directed towards the platform at different angles. Both light sources (104, 105) may be positioned adjacent to the digital camera (101) and arranged to illuminate an object (106) placed on the platform during an image capturing event. In some examples, at least one of the light sources (104, 105) creates shadows off of portions of the object (106). Non-flat objects, relatively tall objects, or documents with curled portions may be likely to have shadows. Without shadow suppression, these shadows may result in the object in the digital images appearing different to the user than the object appears in real life. In the example of FIG. 1, light from the first light source (104) casts shadow (107), and light from the second light source (105) casts shadow (108).

The light sources (104, 105) may include any light source that may be positioned to illuminate the object (106) on the platform (102). Light sources may include components selected from the following non-exhaustive list of electronic flashtubes, mircoflashes, flash bulbs, flash lamps, multi-flash devices, light emitting diodes, flammable powder, or combinations thereof.

The digital camera (101) may be positioned at a fixed location above the platform (102). In some examples, the camera (101) is spaced at a predetermined distance from the platform (102). In some examples, the position of the digital camera (101) is adjustable. For example, the digital camera (101) may be slide into multiple preset locations. In other examples, the camera (101) is movable to any location within a range. For example, the camera (101) may be slide along the post (103) to any desired location.

Any object may be placed onto the platform (102) to be photographed. In some examples, the object (106) is a document. A user may place the document on the surface of the platform (102) with the document's text and/or images facing towards the camera (101). The digital camera (101) may photograph the document to capture an image of the document. Once the image is taken, the system (100) may store the image in memory, print the image, send the image to another location, alter the image, perform another task with the image, or combinations thereof.

The platform (102) may have dimensions large enough to hold standard sizes of documents, books, magazines, other publications, or combinations thereof. For example, the platform may be dimensioned to hold a letter sized document of 8.5 inches by 11 inches, a legal sized document of 8.5 inches by 14 inches, an executive sized document of 7.25 inches by 10.5 inches, an A4 sized document of 8.27 inches by 11.69 inches, an A5 sized document of 5.83 inches by 8.27 inches, an index card sized document of 3 inches by 5 inches, a postcard sized document of 4 inches by 6 inches, other sized documents, or combinations thereof.

A user interface (109) may be located on a base (110) of the platform or other location on the system. In some examples, the user interface (109) is in wireless communication with the processors, camera, or other components of the system. In some examples, the user interface (109) is incorporated into a device in communication with the system (100), such as a desktop computer, a laptop, a tablet, a phone, a watch, another device, or combinations thereof. The user interface (109) may contain options, such to copy the image, print the image, store the image, the transmit the image, reduce/enlarge the image, adjust the image, change the lighting on the image, change the brightness of the image, suppress shadows in the image, suppress glare in the image, other options, or combinations thereof.

In this example, the user interface (109) is requesting the user to select a shadow suppression mode (111) or a glare suppression mode (112). In examples where the object has some height, a shadow may be cast during image capturing events. Thus, a user may desire that the image is taken in a shadow suppression mode. In other examples, the user may recognize that the material of the object to be photographed is likely to create a glare. For example, the user may recognize that a glossy finish or matte finish in text books or magazines may create a glare. As a consequence, the user may select the glare suppression mode prior to taking the image.

The system (100) may also be equipped with a printer to print adjusted imagines or unadjusted images taken with the digital camera (101). In some examples, the system is connected to a network, such as a local area network, the internet, other types of networks, or combinations thereof and may send the images taken with the camera (101) as emails, faxes, other forms of electronic transmission, or combinations thereof. Further, the system (100) may be programmed to convert the digital images to a variety of different electronic formats. For example, the system (100) may initially form the image in a Joint Photographic Experts Group (JPEG) format and convert the image to a Portable Document Format (PDF), other formats, or combinations thereof.

FIG. 2 is a diagram of an illustrative system (200) for taking a digital image, according to principles described herein. In this example, the camera (201) is supported by the post (202), and an object (203) is supported by the platform (204). In the illustrated example, the object (203) is an open book. The camera (201) is spaced apart from the platform (204) at a predetermined, fixed distance (205). Further, the first light source (206) and the second light source (207) are positioned to illuminate the book supported by the platform (204).

In FIG. 2, the pages of the open book may be captured with the digital camera (201). However, in this example, the finish of the book's pages creates a glare. Light from the first light source (206) may create glare in areas (208, 209) on the books pages and are likely to reflect an intense amount of light back towards the camera (201) due to the first light source's first position (210). Additionally, light from the second light source (207) may create glare in areas (211, 212) that are also prone to reflect an intense amount of light back to the camera (201) due to the second light source's second position (213). Without glare suppression, these areas affected by glare may result in the book in the digital images appearing different to the user than the book appears in real life.

A user interface (214) may give the user an option to select a glare suppression mode (215) or a shadow suppression mode (216) prior to instructing the system (200) through the user interface (214) to capture an image of the open book. In some examples, if either mode (215, 216) is selected, multiple digital images of the open book are taken when photographing the book. While each image is being taken, a different light source may be activated to illuminate the book from a different angle. For example, while the first image is taken, the first light source may be illuminated, and while the second image is taken, the second light source may be illuminated. In this manner, the first image may have glare in areas (208, 209), and the second image may have glare in areas (211, 212). In some examples, portions of the first image are replaced with portions of the second image. In this manner, an adjusted image may have reduced or no glare.

In some examples, if neither the glare suppression mode (215) nor the shadow suppression mode (216) are selected prior to photographing the open book, then just a single image of the object (203) is taken with the digital camera (201). However, in alternative examples, the system (201) may instruct the digital camera (201) to take multiple images regardless of whether one of the modes (215, 216) is selected. In some examples, a user may instruct the system (200) to suppress glare or shadows after the images are taken. For example, the digital image may be displayed in the user interface (214), and the user may decide after the image is taken to suppress shadows or glare. If multiple images were taken, the system (200) may create with the adjusted digital image with the information from the multiple images. However, in examples, where just a single digital image was taken, the system may re-photograph the object by taking multiple digital images.

In some examples, the system (200) detects the presence of either glare or shadows in the images. In such an example, the system (200) may select which suppression mode (215, 216) to apply to the images. In some examples, the system (200) recognizes areas affected with glare or shadows in a first image and accordingly instruct that a second image be taken so an adjusted image may be created.

In some examples, the system (200) automatically adjusts the digital image to fix errors identified in the image. For example, errors due to lens distortion may also be corrected. In some examples, the interface gives the user an option to adjust the digital image for such errors. Further, the user interface may give the user an option to edit the digital image through the user interface. For example, the user interface may give the user an option to modify the size, color, brightness, hue, contrast, other parameter of the image, or combinations thereof. In some examples, the user interface allows the user to add text, symbols, marks, or other visual features. Further, the user may have the option to remove features of the image, such a lines, erasure marks, pencil or pen marks, crease marks, other marks, or combinations thereof.

In some examples, the system (200) has a printing mechanism. The printing mechanism may print the image and convey a printed image of the object (203) into a printing tray (217). In other examples, a printer is in communication with the system with a cable, wireless transmitters, over a network, other communication systems, or combinations thereof.

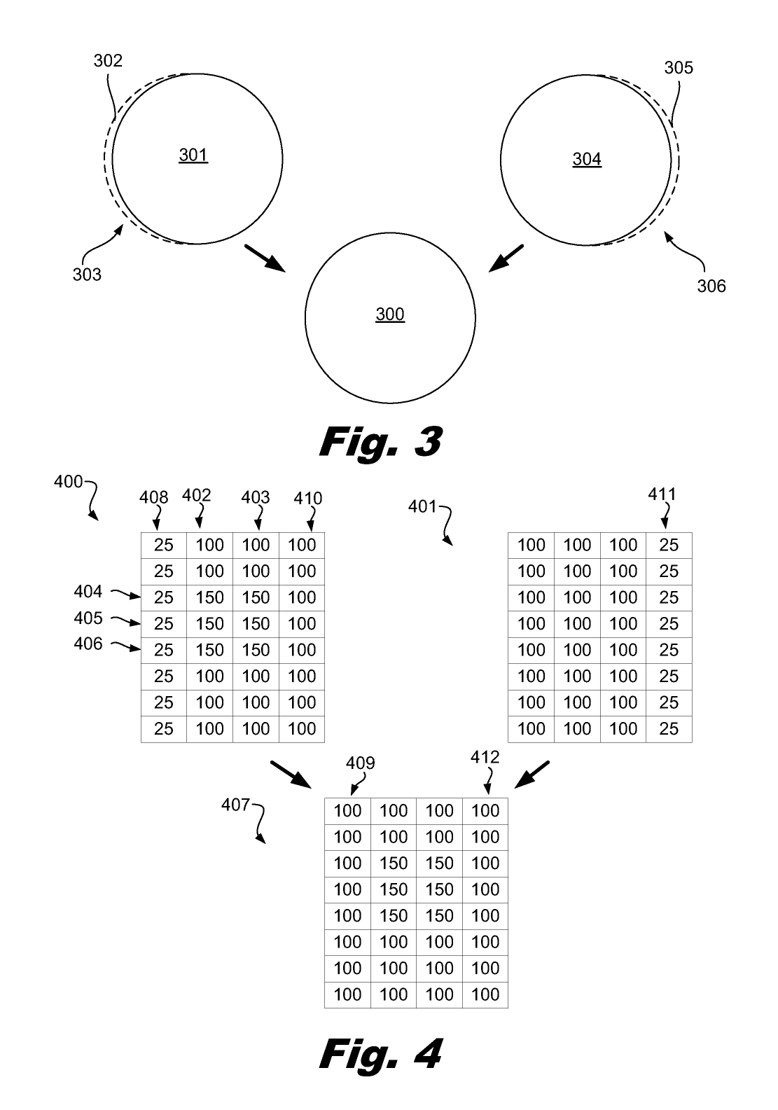

FIG. 3 is a diagram of an illustrative adjusted digital image (300), according to principles described herein. In this example, the object in the adjusted digital image (300) has a cylindrical shape, and the image is of a top orthogonal view of the object. In the illustrated example, a first image (301) taken with light from a first angle casts a first shadow (302) on a left side (303) of the image (301). Also, the illustrated example shows a second image (304) with light from a second angle that casts a second shadow (305) on a right side (306) of the second image (304).

The shadows (302, 305) cause darkened regions in both the first and the second image. In some examples, a shadow suppression mode is selected by a user prior to photographing the object to suppress the shadows (302, 305). In some examples, the user or the system determines to suppress the shadows after the images (301, 304) are taken.

To suppress the shadows (302, 305), the system may select portions of both the first and the second images (301, 304) to create the adjusted digital image (300). Both the first and second digital images (301, 304) may be made of pixels, the smallest area unit in digital images. Each pixel may be assigned a value representative of the light intensity reflected into the digital camera in the corresponding area of the camera's field of view when the digital image is taken. The value of the light intensity corresponds to how bright the pixel's area is within the digital images.

In some examples, each pixel is made of sub-pixels, which are single color regions that contribute to an overall color of a pixel. In examples where the images (301, 304) have sub-pixels, each of the sub-pixels may have sub-values representative of the light intensity of their single color. In some examples, the digital camera uses a color filter, such as a Bayer filter, to filter the appropriate wavelengths of light into each of the sub-pixels by color. For example, if a sub-pixel has a single color of red, a filter may be placed between the incoming light into the camera and the sub-pixel's photoreceptor. This filter may prevent wavelengths of colors other than red from being received by the photoreceptor. In such a manner, each sub-pixel's photoreceptor may record the light intensity per color. The combination of the sub-pixel's sub-values may be combined to arrive at the overall pixel's values. In alternative examples, the pixels are full color pixels.

In examples, where a shadow is cast, the area obstructed from receiving light may reflect a lower light intensity into the appropriate photoreceptors in the digital camera. As a consequence, the light intensities measured with the corresponding photoreceptors are lower.

However, in examples where multiple images are taken with light from different angles, shadows cast from certain light angles may illuminate areas of the three dimensional object that are obstructed from light coming from different angles. As a consequence, the areas in the first image that are darkened due to shadows may be illuminated in the second image since the second image illuminates the darkened region with light from a different angle. The system may select the pixels with the highest values, representing the highest light intensities measured with the photoreceptors. While the first and second digital images (301, 304) were being taken, the digital camera remained in the same positioned; thus, the pixel value differences reflect just the difference resulting from the different light angles.

The adjusted digital image (300) may be created with the higher pixel value per pixel obtained from either the first image (301) or the second image (304). As a consequence, the adjusted digital image may be free of shadows or darkened regions resulting from any particular angle of incoming light.

FIG. 4 is a diagram of illustrative pixel values (400, 401) from a first and a second digital image respectively, according to principles described herein. In this illustrative example, a portion of the pixel values (400) from a first image are shown. Each photoreceptor of the digital camera may represent a pixel in both images, and each photoreceptor may be addressable by column and row. For example, the pixels with a pixel value of 150 units from the first image may be identified as being in the second column (402) and third column (403) and being in the third row (404), fourth row (405), and fifth row (406). Each of the pixels in the first image may have a value representing the light intensity received by the respective photoreceptors in the digital camera at the time that the image was being taken. Likewise, in this example, a portion of the pixel values (401) of the second image are also shown.

In this example, the first and the second images may be taken of the same object with a digital camera from the same angle and distance from the object. However, light was applied to the object at different angles during the capturing of each image. Thus, in this example, the view in both images is the same with the exception of light coming from different angles. Areas in either the first or the second images containing a shadow may have lower pixel values than the other image where the light is directed at the object from a different angle. Since each angle at which each the light is directed may cast different shadows, both the first and the second images may contain lower pixels values than the other for specific pixels as a result of the different shadows.

In the example of FIG. 4, an adjusted image (407) may be created with pixel values selected from either the first or the second images. In this example, the selection is carried out under a shadow suppression made, and as a consequence, the highest values for each pixel are selected for the adjusted digital image (407).

In this example, the pixel values in the first pixel column (408) of the first image have a value of twenty five units, while the pixel values of the same pixels in the second image are each a hundred units. Thus, the pixel values from the second image are selected for the first column (409) in the adjusted digital image (407). Likewise, the pixel values in the fourth column (410) of the first image are greater than the pixel values in the fourth column (411) of the second image. As a consequence, the pixel values for the fourth column (412) of the adjusted digital image (407) are selected from the first image. Further, some of the pixel values in the second and third column (402, 403) are greater than the corresponding pixels of the second image, and as a consequence, these higher pixel values are selected for the adjusted digital image (407).

In FIG. 4, the adjusted digital image (407) has the highest pixel values per pixel from both the first and the second images. As a consequence, darkened areas from either the first or the second images representing shadows may be removed in the adjusted digital image (407). In some examples, where no shadows from the first and the second images overlap, all shadows from the first and the second image may be removed from the adjusted digital image (407).

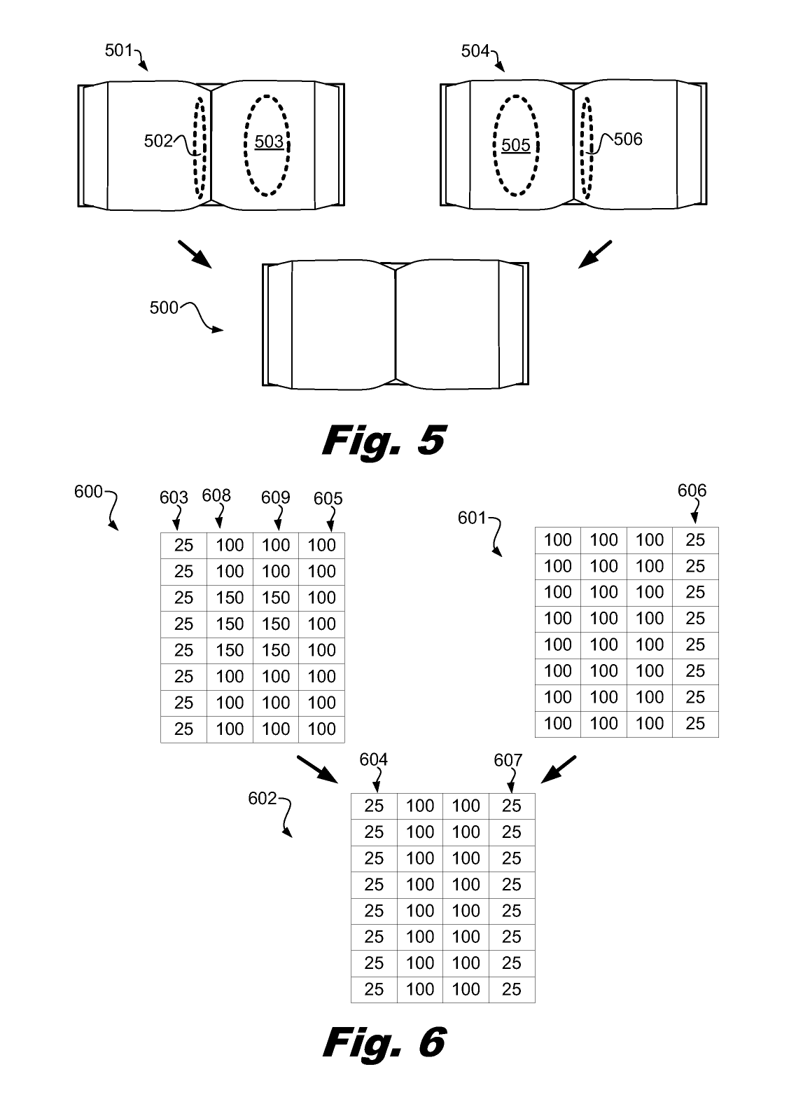

FIG. 5 is a diagram of an illustrative adjusted digital image (500), according to principles described herein. In this example, the adjusted digital image (500) is of a top orthogonal view of a book. In the illustrated example, a first image (501) taken with light from a first angle forms glare on the open book in a first area (502) and a second area (503) of the first image (501). Also, the illustrated example shows a second image (504) with light from a second angle that also creates glare in a third area (505) and a fourth area (506) of the second image (504).

The glare formed in these areas (502, 503, 505, 506) cause washed out regions in both the first and the second image (501, 504) and may represent a high light intensity value per pixel in each image. In some examples, a glare suppression mode is selected by a user prior to photographing the object to suppress the glare. In some examples, the user or the system determines to suppress the glare after the images (501, 504) are taken.

To suppress the glare, the system may select portions of both the first and the second images (501, 504) to create the adjusted digital image (500). In such examples, the lower value pixels are selected for the adjusted digital image (500). In examples where the areas (502, 503, 505, 506) affected by glare do not overlap in the first and second images (501, 504), the glare may be eliminated from the adjusted digital image. In examples where the areas (502, 503, 505, 506) affected by glare do overlap, the glare in the adjusted digital image (500) is reduced.

FIG. 6 is a diagram of illustrative pixel values (600, 601) from a first and a second digital image respectively, according to principles described herein. In this example, the first and the second images may be taken of the same object with a digital camera from the same angle and distance from the object. However, light in these images is applied to the object at different angles. Thus, in this example, the view in both images is the same with the exception of light coming from different angles. Areas affected by glare in either the first or the second image may have higher pixel values than the other image where the light is directed at the object from a different angle. Since each angle that the light is directed at the object may affect different areas with glare, both the first and the second images may contain higher pixels values for specific pixels than the other image as a result of glare.

In the example of FIG. 6, an adjusted image (602) may be created with pixel values selected from either the first or the second images. In this example, the selection is carried out under a glare suppression made, and as a consequence, the lower values for each pixel are selected for the adjusted digital image (602).

In this example, the pixel values in the first pixel column (603) of the first image have a value of twenty five units, while the pixel values of the same pixels in the second image are each a hundred units. Thus, the pixel values from the first image are selected for the first column (604) in the adjusted digital image (602). Likewise, the pixel values in the fourth column (605) of the first image are greater than the pixel values in the fourth column (606) of the second image. As a consequence, the pixel values for the fourth column (607) of the adjusted digital image (602) are selected from the second image. Further, some of the pixel values in the second column (608) and the third column (609) are greater than the corresponding pixels of the second image. As a consequence, the pixel values from the second image are selected for the adjusted digital image (602).

In FIG. 6, the adjusted digital image (602) has the lowest pixel values per pixel from both the first and the second images. As a consequence, areas affected by glare from either the first or the second images may be removed in the adjusted digital image (602).

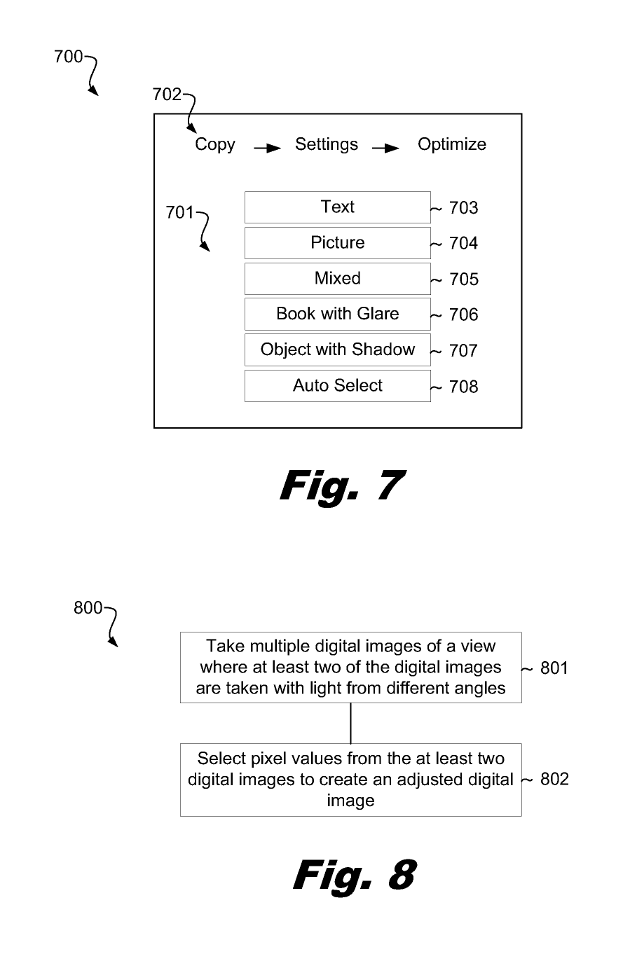

FIG. 7 is a diagram of an illustrative user interface (700), according to principles described herein. The user interface (700) may be attached to a base of the platform that supports the object or another location in the system. In some examples, the user interface (700) is wirelessly connected to the system. The user interface (700) may be in communication with a processor that adjusts digital images taken with the camera.

The user interface (700) may include a display screen, a touch screen, a resistive touch screen, a capacitive touch screen, an optical touch screen, a key pad, a mouse, a video camera to record hand gestures and/or lip movement, a microphone to recognize voice commands, other user interface components, or combinations thereof. In some examples, the user interface (700) presents the user with a menu of options. The menu may include an option to copy an object with the digital camera, search files stored in the system's memory, email a file, convert an image to another electronic format, print an image, adjust an image, perform another task with the image, or combinations thereof.

Under the copy option, the user interface (700) may give the user the option to make a color image or a monochrome image of the object. In some examples, the system assigns an identification number to each image stored in its file. In some examples, the user is given an option to name the image file. In some examples, the system is capable of receiving images through sources other than the digital camera, such as through email. The received images may be adjusted, printed, edited, converted to other electronic formats, or combinations thereof with the system. Further, under the copy option, the user may select a settings option for more options to manipulate the image.

Under the settings option, the user interface (700) may give the user an option to adjust parameters of the image such as lighting, brightness, contrast, other parameters, or combinations thereof. In some examples, the user interface (700) gives the user an option to specify a number of copies to print, an option to resize the image, an option to adjust for magnification errors, other options, or combinations thereof.

In the example of FIG. 7, the user interface (700) is displaying a menu (701) of option to optimize the image. In this example, a user followed an option path (702) of “Copy,” “Settings,” and “Optimize.” In this example, the menu (701) includes a “Text” button (703) to take the user to another menu of options for optimizing the image's text, a “Picture” button (704) to take the user to another menu of options for optimizing the image's pictures, a “Mixed” button (705) to take the user to another menu of options to optimize parameters falling within multiple categories, a “Book with Glare” button (706) to suppress glare, an “Object with Shadow” button (707) to suppress shadows, and an “Auto Select” button (708) to allow the system to automatically select options to optimize the image according to the system's optimization policies. While the user interface (700) has been depicted with specific menu options and menu option paths, any number of options arranged in any number of option paths is within the scope of the principles described herein.

FIG. 8 is a diagram of an illustrative method (800) for creating an adjusted digital image, according to principles described herein. In this example, the method (800) includes taking (801) multiple digital images of a view where at least two of the digital images are taken with light from different angles, and selecting (802) pixel values from the at least two digital images to create an adjusted digital image.

In some examples, the method includes selecting the highest pixel values from each digital image to suppress glare. In alternative examples, selecting the pixel values includes selecting the lowest pixel values from each digital image to suppress shadows. In some examples, the method (800) includes selecting a suppression mode that determines which pixel values to select. For example, the user may select a glare suppression mode which instructs the system to select the lowest pixel values to suppress glare. In alternative examples, the user may select a shadow suppression mode which instructs the system to select the highest pixel values to suppress shadows. A user may choose the suppression mode that determines which pixel values are selected by selecting the suppression mode with a graphics user interface in communication with a processor that creates the adjusted digital image.

In some examples, the method includes taking multiple digitals images with a digital camera and light sources that are secured to a platform upon which an object to be photographed is supported. In some examples, the method also includes taking three digital images of a view with light angled at three different angles. In some examples, each image taken includes illuminating different light sources having different locations for each of the multiple digital images. In alternative examples, reflectors are used with the light sources to control the angle of light. In some examples, a single light source is used to illuminate the object at different angles with a moveable reflector.

The applications for suppressing glare or shadows may be processed in real time. In some examples, the additional processing time to adjust the images may be less than five seconds. In some examples, the additional processing time may take three seconds or less. In some examples, the equations used to suppress glare or shadows use minimal circuitry and, thus, may be good candidates for simple products with little memory or limited processing capabilities.

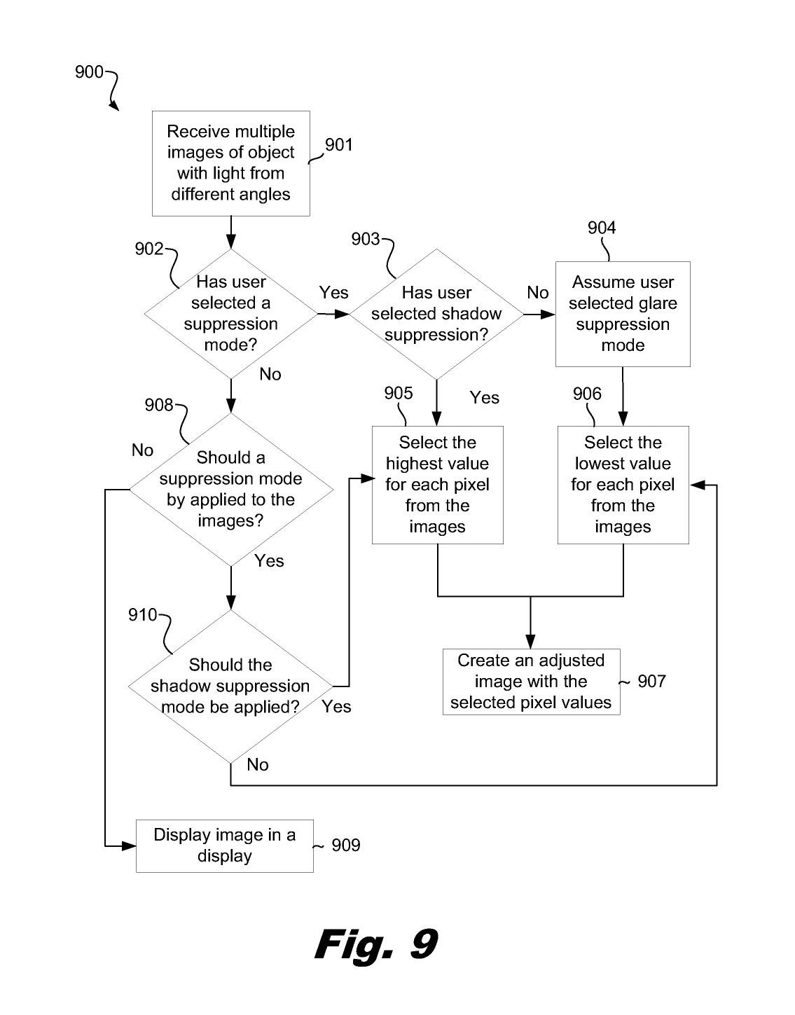

FIG. 9 is a diagram of an illustrative flowchart (900) for creating an adjusted digital image, according to principles described herein. In this example, the flowchart (900) includes receiving (901) multiple images of an object with light from different angles. In some examples, a processor that receives the images may also instruct the digital camera to take the images. However, in alternative examples, the processor may receive the images from other sources, such as email, storage devices connected over a network, a removable storage device, other sources, or combinations thereof.

The flowchart (900) may also include determining (902) whether a user has selected a suppression mode. In this example, if the user has selected a suppression mode, the processor determines (903) whether the user selected the shadow suppression mode. If not, then the processor assumes (904) that the user selected the glare suppression mode. If the user selected the shadow suppression mode, then the processor selects (905) the highest pixel value for each pixel from the images. If the user selected the glare suppression mode, then the processor selects (906) the lowest value for each pixel from the images. With the pixels selected, the flowchart (900) includes creating (907) an adjusted digital image with the selected pixel values.

In FIG. 9, if the user did not select a suppression mode, the processor determines (908) whether a suppression mode should be applied to the images. If the images do not appear as though the images would improve from a suppression mode, then the image may be displayed (909) in a display for the user. On the other hand, if it is determined that a suppression mode should be applied, the processor may determine (910) whether the shadow suppression mode should be applied. If so, the processor selects (905) the highest pixel values from each image and creates (907) an adjusted digital image with the selected highest pixel values. If not, then the processor assumes that the glare suppression mode should be applied and accordingly select (906) the lowest pixel values from each image and create (907) an adjusted digital image with the selected lowest pixel values.

In some examples, other suppression modes with policies for selecting pixels are included in the process. In some examples, the user selects the glare suppression mode, the shadow suppression mode, or another suppression mode after the image is displayed in the display. In some examples, the adjusted digital image is editable through a user interface after the adjustments are made. In some examples, the system automatically detects whether the image should have glare and/or shadow suppression. For examples, the system may detect whether the object to be photographed is a tall object, a curled object, or another object that is likely to create a shadow for shadow suppression. In other examples, the system may detect whether the object fills the entire field of view, is likely to generate little or no shadows, has a reflective surface, or is an object that is otherwise a likely candidate for the glare suppression.

In some examples, the system gives the user an option to select portions of the digital images and further apply separate suppressions modes to the selected regions. For example, some objects may have areas prone for shadows and other areas prone to glare. In such examples, the user may select specific portions of the image through a user interface for shadow suppression and other areas for glare suppression.

Further, the suppression for either glare or shadows may be applied with just some of the images taken. For example, the system may take multiple images with light from multiple angles, and the system may display multiple adjusted images created from different combination of these image. For example, one of the adjusted images may use all of the images to reduce the glare or shadows, while other adjusted images may use different subsets of all of the images. In some examples, if the user views the adjusted image through a user interface and determines that the adjusted image falls short of the user's expectations, and the system may display other adjusted images to the user in case they are closer to the user's expectations.

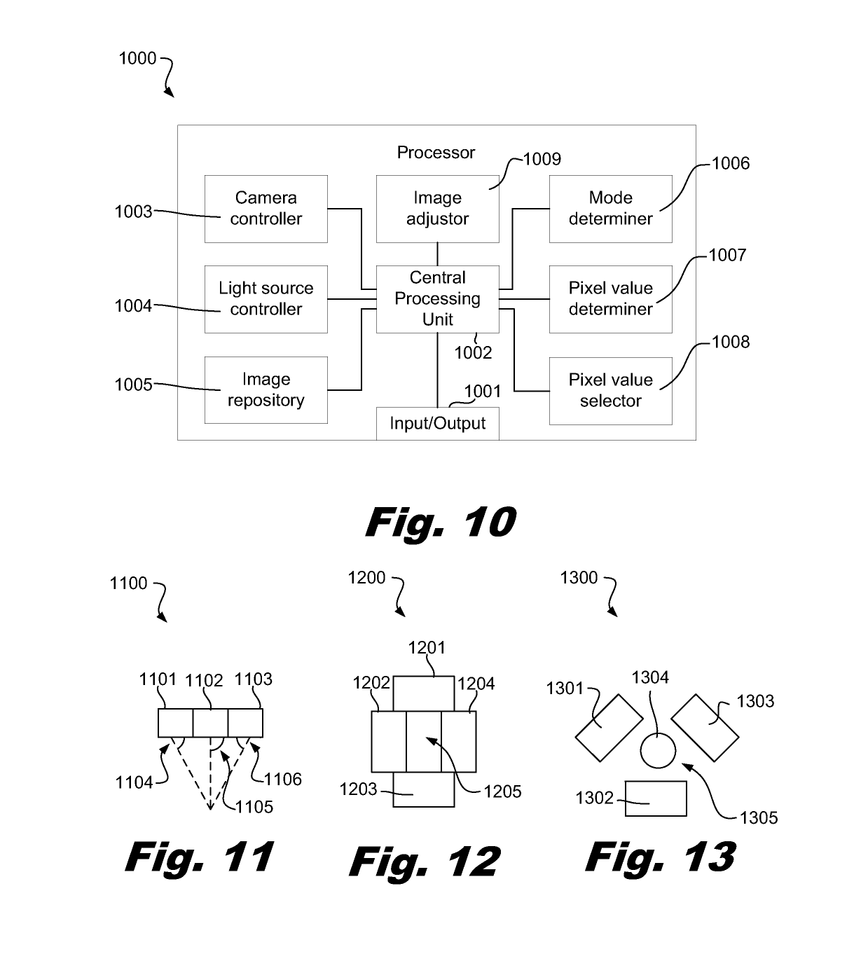

FIG. 10 is a diagram of an illustrative processor (1000), according to principles described herein. In this example, the processor (1000) has an input/output (1001) in communication with a central processing unit (CPU) (1002). The input/output (1001) may be in communication with a digital camera, a user interface, a printer, memory, other devices, or combinations thereof.

The processor (1000) may receive a command from the user interface requesting that a digital image be taken of an object on the platform. Upon receipt of the command to photograph an object, a camera controller (1003) of the processor (600) may send a command to the digital camera to photograph the object. Also, a light source controller (1004) may send instructions to the light sources associated with the digital camera to illuminate at different moments corresponding to the different moments when different images of the object are captured. For example, a first light source at a first position may illuminate when a first image is captured and a second light source at a second position may illuminate when a second image is taken. A digital image of the object may be sent to the processor (1000) and stored in an image repository (1005).

In the illustrated example, the processor (1000) has a mode determiner (1006) to determine whether an image should have shadow, glare, or other aspect of the image suppressed. The mode determiner (1006) may determine which mode should be applied from input from a user through a user interface. In other examples, the processor (1000) has the capacity to analyze the images and determine on its own whether a suppression mode should be applied to the image.

If a suppression mode is applied to the image, a pixel value determiner (1007) may determine the value of each pixel in each of the images. Then a pixel selector (1008) may select the pixels with the appropriate value depending on the selected mode. For example, if a glare suppression mode is selected, the pixel selector (1008) may select the pixels with the lowest value or if the shadow suppression mode is selected, the pixel selector (1008) may select the pixels with the highest value. An image adjustor (1009) may adjust one of the images or create a new image with the selected pixel values.

FIG. 11 is a diagram of a side view of an illustrative arrangement (1100) of light sources, according to principles described herein. In this example, the arrangement (1100) has a first light source (1101), a second light source (1102), and a third light source (1103) arranged in a row and adjacent one another. In this example, at least three images may be taken of the object when the object is photographed. Each of the images may be taken as a different light source is illuminated. For example, the first light source (1101) may illuminate an object at a first angle (1104) while the first image is taken, the second light source (1102) may illuminate the object at a second angle (1105) while the second image is taken, and the third light source (1103) may illuminate an object at a third angle (1106) while the third image is taken.

FIG. 12 is a diagram of a bottom view of an illustrative arrangement (1200) of light sources, according to principles described herein. In this example, the arrangement (1200) has first light source (1201), a second light source (1202), a third light source (1203), and a fourth light source (1204) arranged adjacent to each other and to form a square. In some examples, an opening (1205) between the light sources (1201, 1202, 1203, and 1204) may be used to house the digital camera, a reflector, other component, or combinations thereof.

FIG. 13 is a diagram of a bottom view of an illustrative arrangement (1300) of light sources, according to principles described herein. In this example, the arrangement (1300) has a first light source (1301), a second light source (1302), and a third light source (1303) arranged apart from one another and forming a triangle. In this example, a digital camera (1304) is positioned within an opening (1305) between the light sources (1301, 1302, 1303).

In some examples, multiple light sources are illuminated while a single image is captured. By illuminating multiple light sources during specific image capture events, the light directed towards the object may respond in different ways giving the processor additional images from which to select pixel values. For example, a total of six images may be taken with the light sources (1301, 1302, 1303). In such example, the first light source (1301) may be illuminated while taking the first image, the second light source (1302) may be illuminated while taking the second image, the third light source (1303) may be illuminated while taking the third image, the first and second light sources (1301, 1302) may be illuminated while taking the fourth image, the first and the third light sources (1301, 1303) may be illuminated while taking the fifth image, and the second and the third light source (1302, 1303) may be illuminated while taking the sixth image.

While the arrangement of the light sources and the arrangement of the light sources in relationship to a digital camera have been depicted in the examples above, any arrangement of light sources and any arrangements of light sources with relationship to a digital camera is within the scope of the principles described herein. Further, any type of light source, any amount of power to illuminate any of the light sources, or any other parameter associated with light sources are also within the scope of the principles taught herein. Further, while specific combinations of light sources illuminating while taking specific images have been depicted in the examples above, any combinations of the light source illuminating with images are within the scope of the principles described herein.

While specific pixel values have been depicted in conjunction with specific example above, any pixel values may be selected in accordance with the principles described herein. Further, in some examples, pixel values other than a maximum or minimum value are selected. For example, in a shadow suppression mode, a processor may select a highest pixel value as long as the value is less than a predetermined value threshold. Further, in some examples where a glare suppression mode is used, the processor may select a lowest pixel value as long as the value is more than a predetermined value threshold. In other examples, the pixel values are selected through the use of more complex equations.

Further, while the examples above have described a specific number of images being taken when an object is photographed, any number of images may be taken. In some examples, three or more images may be taken when the object is being photographed.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for creating adjusted digital images with selected pixel values, comprising:
taking multiple digital images of a view where at least two of said digital images are taken with light from different angles; and
selecting pixels values from said at least two of said digital images to create an adjusted digital image.

2. The method of claim 1, wherein selecting pixels values from said at least two of said digital images to create an adjusted digital image includes selecting a highest pixel value for each pixel from each digital image.

3. The method of claim 1, wherein selecting pixels values from said at least two of said digital images to create an adjusted digital image includes selecting a lowest pixel value for each pixel from each digital image.

4. The method of claim 1, further comprising choosing a suppression mode that determines which pixel values are selected.

5. The method of claim 4, wherein choosing a selection mode that determines which pixel values are selected includes selecting said selection mode with a user interface in communication with a processor that creates said adjusted digital image.

6. The method of claim 1, wherein taking multiple digital images of a view where at least two of said digital images are taken with light from different angles includes taking three digital images, wherein each of the three digital images is taken with said light angled at a different angle.

7. The method of claim 1, wherein taking multiple digital images of a view where at least two of said digital images are taken with light from different angles includes illuminating different light sources having different locations for each of said multiple digital images.

8. The method of claim 1, wherein taking multiple digital images of a view where at least two of said digital images are taken with light from different angles includes taking said multiple digital images with a digital camera and light sources that are secured to a platform upon which said object to be photographed is supported.

9. A system for creating adjusted digital images with selected pixel values, comprising:
a digital camera secured to a platform;
light sources arranged to illuminate said platform at different angles;
a user interface in communication with a processor for adjusting images taken with said digital camera; and
said processor is programmed to select pixels values from images taken with said digital camera to create an adjusted digital image.

10. The system of claim 9, wherein said user interface comprises a shadow suppression option that instructs said processor to select maximum pixel values from multiple digital images to create an adjusted digital image.

11. The system of claim 9, wherein said user interface comprises a glare suppression option that instructs said processor to select minimum pixel values from multiple digital images to create an adjusted digital image.

12. The system of claim 9, wherein said digital camera is programmed to take a first image with one of said light source and a second image with another of said light sources.

13. A computer program product, comprising:
a tangible computer readable storage medium, said computer readable storage medium comprising computer readable program code embodied therewith, said computer readable program code comprising:
computer readable program code to receive a first digital image of an object with light from a first angle;
computer readable program code to receive a second digital image of said object with said light from a second angle;
computer readable program code to select pixel image values from both said first and second digital images;
and
computer readable program code to create an adjusted digital image with said selected pixel values.

14. The computer program product of claim 13, further comprising computer readable program code to select pixel image values from both said first and second digital images includes selecting minimum pixel image values when operating under a glare suppression mode.

15. The computer program product of claim 13, wherein computer readable program code to select pixel image values from both said first and second digital images includes selecting maximum pixel image values when operating under a shadow suppression mode.
